(19) United States
(12) Patent Application Publication
(10) Pub. No.: US 2016/0185911 A1
(43) Pub. Date: Jun. 30, 2016

(54) POLYSILOXANE AND HYBRID MATERIAL AND METHOD FOR MANUFACTURING THE SAME

(71) Applicant: INDUSTRIAL TECHNOLOGY RESEARCH INSTITUTE, Hsinchu (TW)

(72) Inventors: Chih-Jen YANG, Zhongli City (TW); Chyi-Ming LEU, Jhudong Township (TW)

(73) Assignee: INDUSTRIAL TECHNOLOGY RESEARCH INSTITUTE, Hsinchu (TW)

(21) Appl. No.: 14/582,342

(22) Filed: Dec. 24, 2014

(51) Int. Cl. C08G 77/04; C08G 77/38

(52) U.S. Cl. CPC C08G 77/04; C08G 77/38

(57) ABSTRACT

Disclosed is a polysiloxane being crosslinked from 0.05 to 20 parts by weight of a second silane and an oligomer of 1 part by weight of a first silane. The first silane is Si(R¹)₂(OR²)₂, each R¹ is independently acrylic group, epoxy group, vinyl group, amino group, aromatic group, or aliphatic group, and each R² is independently aliphatic group. The second silane is Si(R³)(OR⁴)₃, R³ is acrylic group, epoxy group, vinyl group, amino group, aromatic group, or aliphatic group, and each R⁴ is independently aliphatic group.

### TECHNICAL FIELD

The technical field relates to polysiloxane and hybrid material and method for manufacturing the same.

### BACKGROUND

3C electronic products, displays, illuminators, and the like are developed to be light, thin, short, and small. The glass serving as a substrate is gradually scaled down from several micrometers to about 0.1 micrometer, and such fragile glass needs a transparent protection layer. The transparent protection layer usually demands a level of thermal resistance to tolerate the ITO formation process, e.g. at least 300° C. to 350° C. The polymer material serving as the protection layer has inherent coloring problem and yellowing problem at the high temperature. The conventional selection of thermal resistant and transparent material is silicone serial polysiloxane. A novel polysiloxane material or a method for manufacturing the same is called for.

### SUMMARY

One embodiment of the disclosure provides a polysiloxane, being formed by crosslinking 0.05 to 20 parts by weight of a second silane with an oligomer of 1 part by weight of a first silane, wherein the first silane is Si(R¹)₂(OR²)₂, each R¹ is independently acrylic group, epoxy group, vinyl group, amino group, aromatic group, or aliphatic group, and each R² is independently aliphatic group; wherein the second silane is Si(R³)(OR⁴)₃, R³ is acrylic group, epoxy group, vinyl group, amino group, aromatic group, or aliphatic group, and each R⁴ is independently aliphatic group.

One embodiment of the disclosure provides a hybrid material, being formed by reacting the described polysiloxane and 0.01 to 70 parts by weight of an inorganic oxide with a surface having hydroxyl groups.

One embodiment of the disclosure provides a method of forming a polysiloxane, comprising crosslinking 0.05 to 20 parts by weight of a second silane and an oligomer of 1 part by weight of a first silane, wherein the first silane is Si(R¹)₂(OR²)₂, each R¹ is independently acrylic group, epoxy group, vinyl group, amino group, aromatic group, or aliphatic group, and each R² is independently aliphatic group; wherein the second silane is Si(R³)(OR⁴)₃, R³ is acrylic group, epoxy group, vinyl group, amino group, aromatic group, or aliphatic group, and each R⁴ is independently aliphatic group.

One embodiment of the disclosure provides a method of forming a hybrid material, comprising reacting the described polysiloxane and 0.01 to 70 parts by weight of an inorganic oxide with a surface having hydroxyl groups.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows a method of preparing a polysiloxane and a hybrid material in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are shown schematically in order to simplify the drawing.

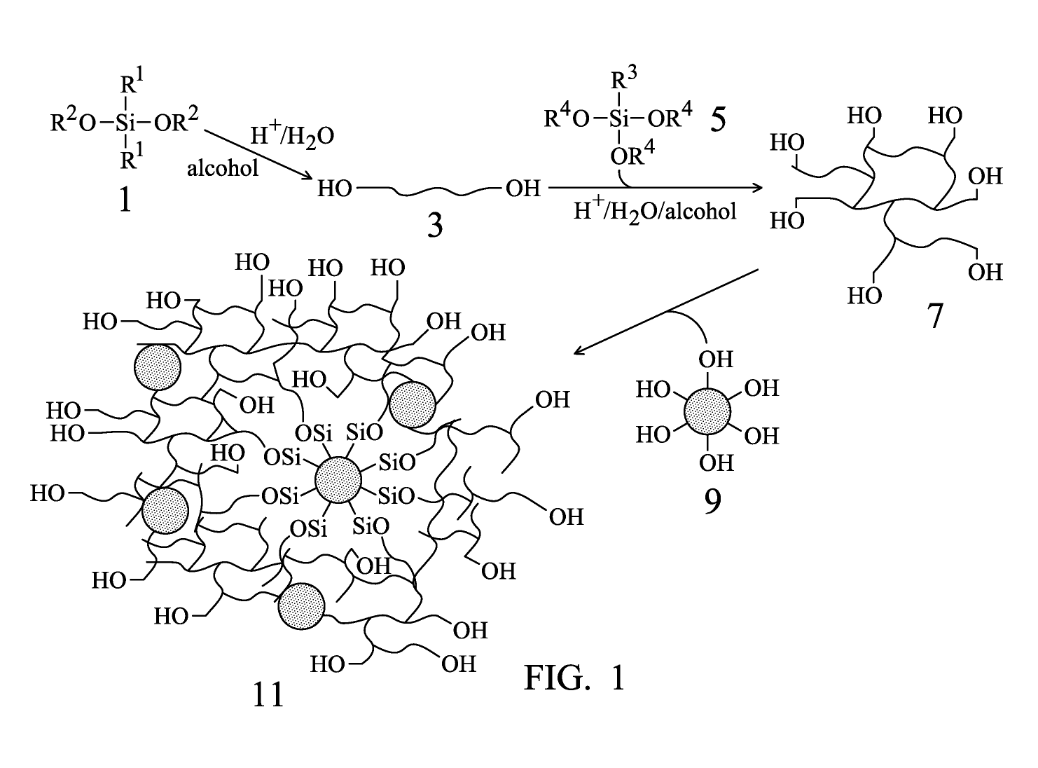

As shown in FIG. 1, 1 part by weight of a first silane 1 is hydrolyzed and polymerized in an acidic aqueous solution to form an oligomer 3. In one embodiment, the first silane 1 is Si(R¹)₂(OR²)₂, each R¹ is independently acrylic group, epoxy group, vinyl group, amino group, aromatic group, or aliphatic group, and each R² is independently aliphatic group. In one embodiment, the acidic aqueous solution further includes alcohol such as methanol, ethanol, isopropyl alcohol, and the likes, to tune the hydrolysis rate. The oligomer may have a viscosity of 10 cps to 500 cps. An overly high viscous oligomer will make the final product haze. An overly low viscous oligomer cannot prevent the gel problem in the following crosslink step.

Subsequently, 0.05 to 20 parts by weight (or 0.1 to 10 parts by weight) of a second silane 5 is mixed with the above oligomer solution, and the mixture is crosslinked to form a polysiloxane (such as hyperbranched polysiloxane 7). The second silane 5 is Si(R³)(OR⁴)₃, R³ is acrylic group, epoxy group, vinyl group, amino group, aromatic group, or aliphatic group, and each R⁴ is independently aliphatic group. An overly high amount of the second silane 5 will make the crosslinked product gel, and the gelled product cannot be further used. An overly low amount of the second silane 5 will lead to the hyperbranched polysiloxane cannot be completely cured after being coated as a film.

In one embodiment, 0.01 to 70 parts by weight of an inorganic oxide 9 with a surface having hydroxyl groups can be reacted with the described hyperbranched polysiloxane 7 to form a hybrid material 11. The hydroxyl groups on the surface of the inorganic oxide 9 and the hydroxyl groups of the hyperbranched polysiloxane 7 may dehydrate to form —O—Si—O— bondings. An overly high amount of the inorganic oxide easily aggregates to lower the transparency of the hybrid material. In one embodiment, the inorganic oxide 9 with a surface having hydroxyl groups can be modified silicon oxide, modified titanium oxide, modified aluminum oxide, or a combination thereof. In one embodiment, the inorganic oxide 9 has a particle size of 0.1 nm to 1000 nm. An overly large particle size of the inorganic oxide may negatively influence the transparency of the product.

The hybrid material 11 can be coated on a substrate such as glass or ceramic, and then heated to be cured to form a protection coating layer. In one embodiment, the protection coating layer has a transparency of 90% to 99.9% and a thermal resistance of about 450° C. The transparent coating of high transparency and high thermal resistance may efficiently protect the substrate.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

### The Second Silane/the First Silane=5:1

10 g of dimethyldimethoxy silane, 72.0 g of isopropyl alcohol, 6.0 g of HCl aqueous solution (0.01M), and 26.3 g of deionized water were poured into a round bottom bottle (1 L) to be mixed. The mixture was stirred at 35° C. for 1.5 hours to be hydrolyzed and polymerized to form an oligomer with a viscosity of 50 to 200 cps. 50 g of methyltrimethoxy silane was then added to the oligomer, and then stirred at 35° C. for 1.5 hours to be crosslinked to form a hyperbranched polysiloxane. The water and the isopropyl alcohol thereof were then removed by a vacuum concentrator to obtain a transparent viscous liquid.

The transparent viscous liquid was coated by a blade to form a film, and then heated to 170° C. to be cured to form a cured film with a thickness of 0.1 to 200 μm by an oven. The cured film had a thermal resistance of 210° C., and a transparency of 92% (measured by a chromatometer).

### Example 2

### The Second Silane/the First Silane=3:1

15 g of dimethyldimethoxy silane, 72.0 g of isopropyl alcohol, 6.0 g of HCl aqueous solution (0.01M), and 26.6 g of deionized water were poured into a round bottom bottle (1 L) to be mixed. The mixture was stirred at 35° C. for 1.5 hours to be hydrolyzed and polymerized to form an oligomer with a viscosity of 50 to 200 cps. 45 g of methyltrimethoxy silane was then added to the oligomer, and then stirred at 35° C. for 1.5 hours to be crosslinked to form a hyperbranched polysiloxane. The water and the isopropyl alcohol thereof were then removed by a vacuum concentrator to obtain a transparent viscous liquid.

The transparent viscous liquid was coated by a blade to form a film, and then heated to 170° C. to be cured to form a cured film with a thickness of 0.1 to 200 μm by an oven. The cured film had a thermal resistance of 210° C., and a transparency of 92% (measured by a chromatometer).

### Example 3

### The Second Silane/the First Silane=1:1

30 g of dimethyldimethoxy silane, 72.0 g of isopropyl alcohol, 6.0 g of HCl aqueous solution (0.01M), and 27.8 g of deionized water were poured into a round bottom bottle (1 L) to be mixed. The mixture was stirred at 35° C. for 1.5 hours to be hydrolyzed and polymerized to form an oligomer with a viscosity of 50 to 200 cps. 30 g of methyltrimethoxy silane was then added to the oligomer, and then stirred at 35° C. for 1.5 hours to be crosslinked to form a hyperbranched polysiloxane. The water and the isopropyl alcohol thereof were then removed by a vacuum concentrator to obtain a transparent viscous liquid.

The transparent viscous liquid was coated by a blade to form a film, and then heated to 210° C. to be cured to form a cured film with a thickness of 0.1 to 200 μm by an oven. The cured film had a thermal resistance of 210° C., and a transparency of 92% (measured by a chromatometer).

### Example 4

### The Second Silane/the First Silane=1:3

45 g of dimethyldimethoxy silane, 72.0 g of isopropyl alcohol, 6.0 g of HCl aqueous solution (0.01M), and 28.8 g of deionized water were poured into a round bottom bottle (1 L) to be mixed. The mixture was stirred at 35° C. for 1.5 hours to be hydrolyzed and polymerized to form an oligomer with a viscosity of 50 to 200 cps. 15 g of methyltrimethoxy silane was then added to the oligomer, and then stirred at 35° C. for 1.5 hours to be crosslinked to form a hyperbranched polysiloxane. The water and the isopropyl alcohol thereof were then removed by a vacuum concentrator to obtain a transparent viscous liquid.

The transparent viscous liquid was coated by a blade to form a film, and then heated to 210° C. to be cured to form a cured film with a thickness of 0.1 to 200 m by an oven. The cured film had a thermal resistance of 300° C., and a transparency of 92% (measured by a chromatometer).

### Example 5

### The Second Silane/the First Silane=1:10

54.5 g of dimethyldimethoxy silane, 72.0 g of isopropyl alcohol, 6.0 g of HCl aqueous solution (0.01M), and 30.1 g of deionized water were poured into a round bottom bottle (1 L) to be mixed. The mixture was stirred at 35° C. for 1.5 hours to be hydrolyzed and polymerized to form an oligomer with a viscosity of 50 to 200 cps. 5.45 g of methyltrimethoxy silane was then added to the oligomer, and then stirred at 35° C. for 1.5 hours to be crosslinked to form a hyperbranched polysiloxane. The water and the isopropyl alcohol thereof were then removed by a vacuum concentrator to obtain a transparent viscous liquid.

The transparent viscous liquid was coated by a blade to form a film, and then heated to 210° C. to be cured to form a cured film with a thickness of 0.1 to 200 μm by an oven. The cured film had a thermal resistance of 400° C., and a transparency of 92% (measured by a chromatometer).

### Comparative Example 1

### The Second Silane/the First Silane=12:1

4.62 g of dimethyldimethoxy silane, 72.0 g of isopropyl alcohol, 6.0 g of HCl aqueous solution (0.01M), and 25.4 g of deionized water were poured into a round bottom bottle (1 L) to be mixed. The mixture was stirred at 35° C. for 1.5 hours to be hydrolyzed and polymerized to form an oligomer with a viscosity of 50 to 200 cps. 55.4 g of methyltrimethoxy silane was then added to the oligomer, and then stirred at 35° C. for 1.5 hours to be crosslinked to form a hyperbranched polysiloxane. The water and the isopropyl alcohol thereof were then removed by a vacuum concentrator to obtain a transparent viscous liquid. The transparent viscous liquid was gelled in short time and could not be further used.

### Comparative Example 2

### The Second Silane/the First Silane=1:20

57.1 g of dimethyldimethoxy silane, 72.0 g of isopropyl alcohol, 6.0 g of HCl aqueous solution (0.01M), and 29.7 g of deionized water were poured into a round bottom bottle (1 L) to be mixed. The mixture was stirred at 35° C. for 1.5 hours to be hydrolyzed and polymerized to form an oligomer. 2.86 g of methyltrimethoxy silane was then added to the oligomer, and then stirred at 35° C. for 1.5 hours to be crosslinked to form a hyperbranched polysiloxane. The water and the isopropyl alcohol thereof were then removed by a vacuum concentrator to obtain a transparent viscous liquid.

The transparent viscous liquid was coated by a blade to form a film, and then heated to 400° C. to be cured to form a cured film with a thickness of 0.1 to 200 μm. The film could not be completely cured.

### Comparative Example 3

### The Second Silane/the First Silane=3:1, and the First Silane and the Second Silane were Simultaneously Reacted

15.0 g of dimethyldimethoxy silane, 45.0 g of methyltrimethoxy silane, 72.0 g of isopropyl alcohol, 6.0 g of HCl aqueous solution (0.01M), and 26.6 g of deionized water were poured into a round bottom bottle (1 L) to be mixed. The mixture was stirred at 35° C. for 1.5 hours to be gelled and could not be further used.

### Comparative Example 4

### The Second Silane/the First Silane=1:1, and the First Silane and the Second Silane were Simultaneously Reacted

30.0 g of dimethyldimethoxy silane, 30.0 g of methyltrimethoxy silane, 72.0 g of isopropyl alcohol, 6.0 g of HCl aqueous solution (0.01M), and 27.8 g of deionized water were poured into a round bottom bottle (1 L) to be mixed. The mixture was stirred at 35° C. for 1.5 hours to be gelled and could not be further used.

### Comparative Example 5

### The Second Silane/the First Silane=1:3, and the First Silane and the Second Silane were Simultaneously Reacted

45.0 g of dimethyldimethoxy silane, 15.0 g of methyltrimethoxy silane, 72.0 g of isopropyl alcohol, 6.0 g of HCl aqueous solution (0.01M), and 16.06 g of deionized water were poured into a round bottom bottle (1 L) to be mixed. The mixture was stirred at 35° C. for 1.5 hours to form a transparent viscous liquid. The transparent viscous liquid was coated by a blade to form a film, and then heated to 210° C. to be cured to form a cured film with a thickness of 0.1 to 200 μm. The cured film was cracked.

### Comparative Example 6

### The Second Silane/the First Silane=1:1, the Second Silane was Polymerized to Form an Oligomer which was then Reacted with the First Silane

30 g of Methyltrimethoxy silane, 72.0 g of isopropyl alcohol, 6.0 g of HCl aqueous solution (0.01M), and 27.8 g of deionized water were poured into a round bottom bottle (1 L) to be mixed. The mixture was stirred at 35° C. for 1.5 hours to be hydrolyzed and polymerized to form an oligomer. 30 g of dimethyldimethoxy silane was then added to the oligomer, and then stirred at 35° C. for 1.5 hours to be crosslinked to form a hyperbranched polysiloxane. The water and the isopropyl alcohol thereof were then removed by a vacuum concentrator to obtain a transparent viscous liquid. The transparent viscous liquid was gelled in short time and could not be further used.

TABLE 1

| | | The second | | |
|---|---|---|---|---|
| | Addition | silane/the first | | |
| | sequence | silane | Product | Film property |
| Example 1 | The first silane | 5:1 | Transparent | Transparent and |
| | was pre-reacted | | | excellent film- |
| | to form an | | | formability |
| Example 2 | oligomer, and the | 3:1 | Transparent | Transparent and |
| | second silane | | | excellent film- |
| | was then added | | | formability |
| Example 3 | to cros slink with | 1:1 | Transparent | Transparent and |
| | the oligomer | | | excellent film- |
| | | | | formability |
| Example 4 | | 1:3 | Transparent | Transparent and |
| | | | | excellent film- |
| | | | | formability |
| Example 5 | | 1:10 | Transparent | Transparent and |
| | | | | excellent film- |
| | | | | formability |
| Comparative | | 12:1 | Transparent | Could not form a |
| Example 1 | | | viscous liquid | film |
| | | | gelled in short | |
| | | | time | |
| Comparative | | 1:20 | Transparent | Incompletely |
| Example 2 | | | | cured |
| Comparative | The first silane | 3:1 | Gel | Could not form a |
| Example 3 | and the second | | | film |
| Comparative | silane were | 1:1 | Gel | Could not form a |
| Example 4 | simultaneously | | | film |
| Comparative | reacted | 1:3 | Transparent | Cracked film |
| Example 5 | | | | |
| Comparative | The second | 1:1 | Gel | Could not form a |
| Example 6 | silane was pre- | | | film |
| | reacted, and the | | | |
| | first silane was | | | |
| | then added to | | | |
| | react | | | |

As shown in Table 1, the sequence of pre-reacting the first silane to form an oligomer, and crosslinking the oligomer with the second silane was necessary. Moreover, the first silane and the second silane should have an appropriate ratio. If the first silane and the second silane were simultaneously reacted, or the second silane was reacted to form the oligomer which was then reacted with the first silane, the product would be gelled or have poor film formability.

### Example 6

### The Second Silane/the First Silane=3:1, and the Hyperbranched Polysiloxane/Silicon Oxide=70:30

15.0 g of dimethyldimethoxy silane, 72.0 g of isopropyl alcohol, 6.0 g of HCl aqueous solution (0.01M), and 16.06 g of deionized water were poured into a round bottom bottle (1 L) to be mixed. The mixture was stirred at 35° C. for 1.5 hours to be hydrolyzed and polymerized to form an oligomer with a viscosity of 50 to 200 cps. 45 g of 3-(trimethoxy silyl)propyl methacrylate and 68.69 g of an isopropyl alcohol dispersion of silicon oxide (IPA-ST, commercially available from Nissan Chemical) were then added to the oligomer, and then stirred at 35° C. for 1.5 hours to form a hybrid material of a hyperbranched polysiloxane reacted with the silicon oxide. The water and the isopropyl alcohol thereof were then removed by a vacuum concentrator to obtain a pale yellow transparent liquid (59.30 g) with a silicon oxide content of 30.43 wt % and a hyperbranched polysiloxane content of 69.57 wt %. The pale yellow transparent liquid was coated by a blade to form a film, and then heated to 170° C. to be cured to form a cured film with a thickness of 0.1 to 200 μm by an oven. The cured film had a thermal resistance of 210° C., and a transparency of 92% (measured by a chromatometer).

### Example 7

### The Second Silane/the First Silane=10:1, and the Hyperbranched Polysiloxane/Silicon Oxide=72:28

6.0 g of dimethyldimethoxy silane, 79.2 g of isopropyl alcohol, 6.6 g of HCl aqueous solution (0.01M), and 14.42 g of deionized water were poured into a round bottom bottle (1 L) to be mixed. The mixture was stirred at 35° C. for 1.5 hours to be hydrolyzed and polymerized to form an oligomer with a viscosity of 50 to 200 cps. 60.0 g of 3-(trimethoxy silyl)propyl methacrylate and 76.58 g of the isopropyl alcohol dispersion of silicon oxide (IPA-ST, commercially available from Nissan Chemical) were then added to the oligomer, and then stirred at 35° C. for 1.5 hours to form a hybrid material of a hyperbranched polysiloxane reacted with the silicon oxide. The water and the isopropyl alcohol thereof were then removed by a vacuum concentrator to obtain a pale yellow transparent liquid (80.20 g) with a silicon oxide content of 28.65 wt % and a hyperbranched polysiloxane content of 71.35 wt %. The pale yellow transparent liquid was coated by a blade to form a film, and then heated to 170° C. to be cured to form a cured film with a thickness of 0.1 to 200 μm by an oven. The cured film had a thermal resistance of 210° C., and a transparency of 92% (measured by a chromatometer).

### Example 8

### The Second Silane/the First Silane=10:1, and the Hyperbranched Polysiloxane/Silicon Oxide=62:38

6.0 g of dimethyldimethoxy silane, 79.2 g of isopropyl alcohol, 6.6 g of HCl aqueous solution (0.01M), and 14.42 g of deionized water were poured into a round bottom bottle (1 L) to be mixed. The mixture was stirred at 35° C. for 1.5 hours to be hydrolyzed and polymerized to form an oligomer with a viscosity of 50 to 200 cps. 60.0 g of 3-(trimethoxy silyl)propyl methacrylate and 76.58 g of the isopropyl alcohol dispersion of silicon oxide (IPA-ST, commercially available from Nissan Chemical) were then added to the oligomer, and then stirred at 35° C. for 10 minutes to form a hybrid material of a hyperbranched polysiloxane reacted with the silicon oxide. The water and the isopropyl alcohol thereof were then removed by a vacuum concentrator to obtain a pale yellow transparent liquid (92.70 g) with a silicon oxide content of 38.55 wt % and a hyperbranched polysiloxane content of 61.45 wt %. The pale yellow transparent liquid was coated by a blade to form a film, and then heated to 170° C. to be cured to form a cured film with a thickness of 0.1 to 200 μm by an oven. The cured film had a thermal resistance of 210° C., and a transparency of 92% (measured by a chromatometer).

### Example 9

### The Second Silane/the First Silane=1:1, and the Hyperbranched Polysiloxane/Silicon Oxide=90:10

50.0 g of dimethyldimethoxy silane, 60 g of isopropyl alcohol, 5.6 g of HCl aqueous solution (0.01M), and 9.4 g of deionized water were poured into a round bottom bottle (1 L) to be mixed. The mixture was stirred at 35° C. for 2 hours to be hydrolyzed and polymerized to form an oligomer with a viscosity of 50 to 200 cps. 50.0 g of methyltrimethoxy silane was then added to the oligomer, and stirred at 35° C. for 1.5 hours to form a hyperbranched polysiloxane. 20.0 g of the isopropyl alcohol dispersion of silicon oxide (IPA-ST, commercially available from Nissan Chemical) was then added to the hyperbranched polysiloxane, and stirred at 35° C. for 10 minutes to form a hybrid material of the hyperbranched polysiloxane reacted with the silicon oxide. The water and the isopropyl alcohol thereof were then removed by a vacuum concentrator to obtain a transparent liquid (65.2 g) with a silicon oxide content of 10 wt % and a hyperbranched polysiloxane content of 90 wt %. The transparent liquid was coated by a blade to form a film, and then heated to 210° C. to be cured to form a cured film with a thickness of 0.1 to 200 μm by an oven. The cured film had a thermal resistance of 210° C., and a transparency of 92% (measured by a chromatometer).

### Example 10

### The Second Silane/the First Silane=1:10, and the Hyperbranched Polysiloxane/Silicon Oxide=93:7

30.0 g of dimethyldimethoxy silane, 10 g of isopropyl alcohol, 2 g of HCl aqueous solution (0.01M), and 5.1 g of deionized water were poured into a round bottom bottle (1 L) to be mixed. The mixture was stirred at 35° C. for 1.5 hours to be hydrolyzed and polymerized to form an oligomer with a viscosity of 50 to 200 cps. 3.0 g of methyltrimethoxy silane was then added to the oligomer, and stirred at 35° C. for 1.5 hours to form a hyperbranched polysiloxane. 6.0 g of the isopropyl alcohol dispersion of silicon oxide (IPA-ST, commercially available from Nissan Chemical) was then added to the hyperbranched polysiloxane, and stirred at 35° C. for 10 minutes to form a hybrid material of the hyperbranched polysiloxane reacted with the silicon oxide. The water and the isopropyl alcohol thereof were then removed by a vacuum concentrator to obtain a transparent liquid (22.1 g) with a silicon oxide content of 7 wt % and a hyperbranched polysiloxane content of 93 wt %. The transparent liquid was coated by a blade to form a film, and then heated to 210° C. to be cured to form a cured film with a thickness of 0.1 to 200 μm by an oven. The cured film had a thermal resistance of 400° C., and a transparency of 92% (measured by a chromatometer).

TABLE 2

| | | The | Hyperbranched | |
|---|---|---|---|---|
| | | second | polysiloxane/ | |
| | The second | silane/the | silicon | |
| | silane | first silane | oxide | Film formability |
| Example 6 | 3- | 3:1 | 70:30 | Transparent and |
| | (Trimethoxy | | | excellent film- |
| | silyl) propyl | | | formability |
| | methacrylate | | | |
| Example 7 | | 10:1 | 72:28 | Transparent and |
| | | | | excellent film- |
| | | | | formability |
| Example 8 | | 10:1 | 62:38 | Transparent and |
| | | | | excellent film- |
| | | | | formability |
| Example 9 | Methyl- | 1:1 | 90:10 | Transparent and |
| | trimethoxy | | | excellent film- |
| | silane | | | formability |
| Example | | 1:10 | 93:7 | Transparent and |
| 10 | | | | excellent film- |
| | | | | formability |

As shown in Table 2, several substituted groups can be selected for the second silane.

### Comparative Example 7

30.0 g of commercially available polydimethylsiloxane (DMS-S35, commercially available from Gelest) with a viscosity of 5000 cps, 30.0 g of methyltrimethoxy silane, 72.0 g of isopropyl alcohol, 6.0 g of HCl aqueous solution (0.01M), and 16.06 g of deionized water were poured into a round bottom bottle (1 L) to be mixed. The methyltrimethoxy silane and the DMS-S35 could not mix with each other, thereby forming a hazy liquid that was separated in two layers.

### Comparative Example 8

10.0 g of commercially available polydimethylsiloxane (DMS-S35, commercially available from Gelest) with a viscosity of 5000 cps and 10.0 g of the isopropyl alcohol dispersion of silicon oxide (IPA-ST, commercially available from Nissan Chemical) were poured into a round bottom bottle (1 L) to be mixed. The isopropyl alcohol dispersion of silicon oxide and the DMS-S35 could not mix with each other, thereby forming a hazy liquid that was separated in two layers.

As shown in Comparative Examples 7 and 8, if the oligomer formed by hydrolyzing and polymerizing the first silane was replaced with a polymer with a higher viscosity, the transparent film could not be formed.

It will be apparent to those skilled in the art that various modifications and variations can be made to the disclosed methods and materials. It is intended that the specification and examples be considered as exemplary only, with a true scope of the disclosure being indicated by the following claims and their equivalents.

1. A polysiloxane, being
formed by crosslinking 0.05 to 20 parts by weight of a second silane and an oligomer of 1 part by weight of a first silane,
wherein the first silane is Si(R¹)₂(OR²)₂, each R¹ is independently acrylic group, epoxy group, vinyl group, amino group, aromatic group, or aliphatic group, and each R² is independently aliphatic group;
wherein the second silane is Si(R³)(OR⁴)₃, R³ is acrylic group, epoxy group, or aromatic group, and each R⁴ is independently aliphatic group.

2. The polysiloxane as claimed in claim 1, wherein the oligomer of the first silane has a viscosity of 10 cps to 500 cps at 35° C.

3. A hybrid material, being
formed by reacting the polysiloxane as claimed in claim 1 and 0.01 to 70 parts by weight of an inorganic oxide with a surface having hydroxyl groups.

4. The hybrid material as claimed in claim 3, wherein the inorganic oxide with the surface having hydroxyl groups comprises modified silicon oxide, modified titanium oxide, modified aluminum oxide, or a combination thereof.

5. The hybrid material as claimed in claim 3, wherein the inorganic oxide with the surface having hydroxyl groups has a particle size of 0.1 nm to 1000 nm.

6. A method of forming a polysiloxane, comprising:
crosslinking 0.05 to 20 parts by weight of a second silane and an oligomer of 1 part by weight of a first silane,
wherein the first silane is Si(R¹)₂(OR²)₂, each R¹ is independently acrylic group, epoxy group, vinyl group, amino group, aromatic group, or aliphatic group, and each R² is independently aliphatic group;
wherein the second silane is Si(R³)(OR⁴)₃, R³ is acrylic group, epoxy group, or aromatic group, and each R⁴ is independently aliphatic group.

7. The method as claimed in claim 6, wherein the oligomer of the first silane has a viscosity of 10 cps to 500 cps at 35° C.

8. A method of forming a hybrid material, comprising:
reacting the polysiloxane as claimed in claim 1 and 0.01 to 70 parts by weight of an inorganic oxide with a surface having hydroxyl groups.

9. The method as claimed in claim 8, wherein the inorganic oxide with the surface having hydroxyl groups comprises modified silicon oxide, modified titanium oxide, modified aluminum oxide, or a combination thereof.

10. The method as claimed in claim 8, wherein the inorganic oxide with the surface having hydroxyl groups has a particle size of 0.1 nm to 1000 nm.
